(19) United States
(12) Patent Application Publication
(10) Pub. No.: US 2006/0201431 A1
(43) Pub. Date: Sep. 14, 2006

(54) Personal hummingbird blind

(76) Inventor: Walter L. Peterson, St. Louis, MO (US)

Correspondence Address: LAW OFFICE OF CHARLES W. PETERSON, JR., 11703 BOWMAN GREEN DR., SUITE 100, RESTON, VA, 20190, US

(21) Appl. No.: 11/075,447

(22) Filed: Mar. 9, 2005

(51) Int. Cl. A01K 39/00

(52) U.S. Cl. 119/51.01

(57) ABSTRACT

A blind for attracting and observing animals, a wearable hummingbird blind for observing feeding hummingbirds in close proximity, and a hummingbird feeder. The blind includes head covering colored to draw hummingbirds and suitable for hiding from view, at least a human forehead. A breath diverter diverts the wearer's breath from feeding hummingbirds. Birdfeeders around the wearer's head hold bait to draw hummingbirds to the wearer.

### FIELD OF THE INVENTION

The present invention is related to a blind for observing animals at close range; and more particularly, to a personal bird blind for observe birds such as hummingbirds up close.

### BACKGROUND OF THE INVENTION

Many people enjoy viewing hummingbirds. People place hummingbird feeders outside their home windows to view feeding hummingbirds.

Hummingbirds have a natural fear of people. Consequently, because hummingbirds are skittish, it is difficult for people to observe hummingbirds at very close ranges.

Thus, there is a need for a hummingbird blind that allows people to observe hummingbirds at extremely close range without scaring off the birds.

### SUMMARY OF THE INVENTION

The present invention is related to a blind for attracting and observing animals, a wearable hummingbird blind for observing feeding hummingbirds in close proximity, and a hummingbird feeder. The blind includes head covering colored to draw hummingbirds and suitable for hiding from view, at least a human forehead. A breath diverter diverts the wearer's breath from feeding hummingbirds. Birdfeeders around the wearer's head hold bait to draw hummingbirds to the wearer

### BRIEF DESCRIPTION OF THE DRAWINGS

The foregoing and other objects, aspects and advantages will be better understood from the following detailed description of a preferred embodiment of the invention with reference to the drawings, in which:

FIG. 1A-B show an example of a personal hummingbird blind for drawing hummingbirds to within inches of the user's face, according to a preferred embodiment of the present invention;

FIG. 2 shows an example of a side feeder;

FIG. 3 shows an example of a top feeder.

### DESCRIPTION OF PREFERRED EMBODIMENTS

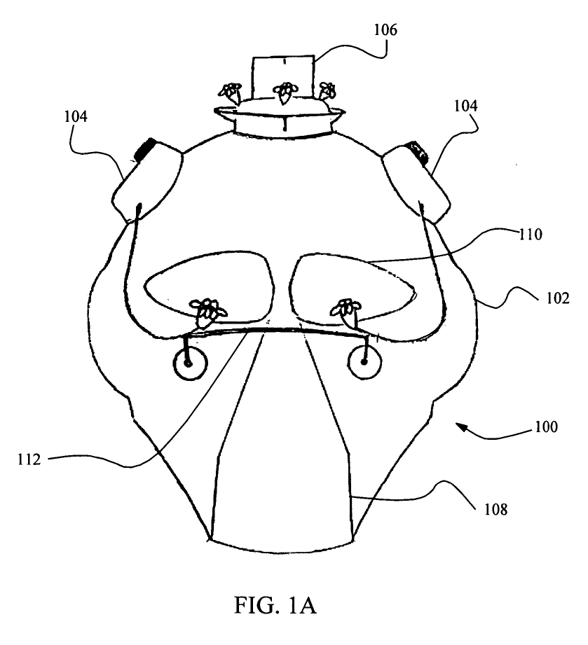

FIGS. 1A-B show a front and side view, respectively, of an example of a personal bird blind 100 that draws feeding birds, e.g. hummingbirds, to within inches of the blind 100, according to a preferred embodiment of the present invention. Preferably, the personal bird blind 100 includes head covering or headwear 102 that, when worn by a user, covers the wearer's face. This example shows side feeders 104 on both the left and right sides of the headwear 102. Optionally, a top feeder 106 may be located at the top of the headwear 102. Any combination of the side feeders 104 and top feeders 106 will suffice, but all three are preferred. Preferably, a breath guard 108 is located at the front of the headwear 102. Also, in this example eye protection 110 covers the user's eyes. An optional bird perch 112 may be located at and extending from the breath guard 108 into the line of sight of a wearer.

Preferably, the headwear 102 is selected such that it camouflages the user and, also, visually attracts birds. The side feeders 104 and top feeder 106 hold bait to entice hummingbirds. Normally, even if an approaching hummingbird does not sense danger from the human, the bird avoids a human face The inventor has found that, this is because the hummingbird is avoiding the heat of human's breath. Thus, advantageously, the breath guard 108 deflects a wearer's breath away from approaching and feeding hummingbirds; and, birds will come up to the blind, unperturbed by the breath of a user wearing the blind. Since feeding hummingbirds have long sharp beaks, the eye protection 110 guards the wearer's eyes from those sharp beaks that may be within close proximity. Also, the optional bird perch 112 places resting hummingbirds up close and in view.

The preferred headwear 102 camouflages or masks the user by hiding identifiable human features, e.g. the user's nose, hair and mouth. Also, the headwear 102 may be colored to suggest a flower and thus, visually attract hummingbirds, e.g., headwear 102 may by solid red, orange, yellow or some combination or floral combination thereof. Examples of suitable headwear 102 include: a welding helmet, a beekeeper's mask, a construction helmet, a bandana, a hood, a cloak, or anything else that masks a portion of the user's head without scaring hummingbirds. In one particular example, the headwear 102 is a red mask and more particularly, a mask similar to the mask worn by the Spider-Man™ character of Marvel® Comics. It should be noted the above examples of headwear 102 (e.g., the Spider-Man™ mask) are provided for example only and not intended as limitations.

Suitable breath guards 108 include, for example, a surgeon's mask, a welding mask, a bandanna or anything else used to direct or defuse the user's breath away from hummingbirds as they feed. In a particular example, the breath guard 108 is a handkerchief wrapped in front of the user's face to cover the user's nose and mouth.

Optional eye protection 110 shields the user's eyes from the beaks of hummingbirds. Eye protection 110 may also camouflage the user's eyes from hummingbirds as they feed. Suitable eye protection 110 may include, for example, safety glasses, sunglasses, a welding mask, a beekeeper mask, goggles or anything that can protect the eyes of the user from hummingbird beaks. In particular, the eye protection 110 may be a pair of goggles, for example.

Also in this example of FIGS. 1A-B, an optional bird perch 112 is shown attached to the breath guard 108, just beneath the eye protection 110. The perch 112 extends away from the mask to place perched hummingbirds in the line of sight of the user. Flower cuttings may be clipped to the perch 112 for an additional hummingbird lure. Thus, the optional bird perch 112 allows the user to observe perched hummingbirds between feedings.

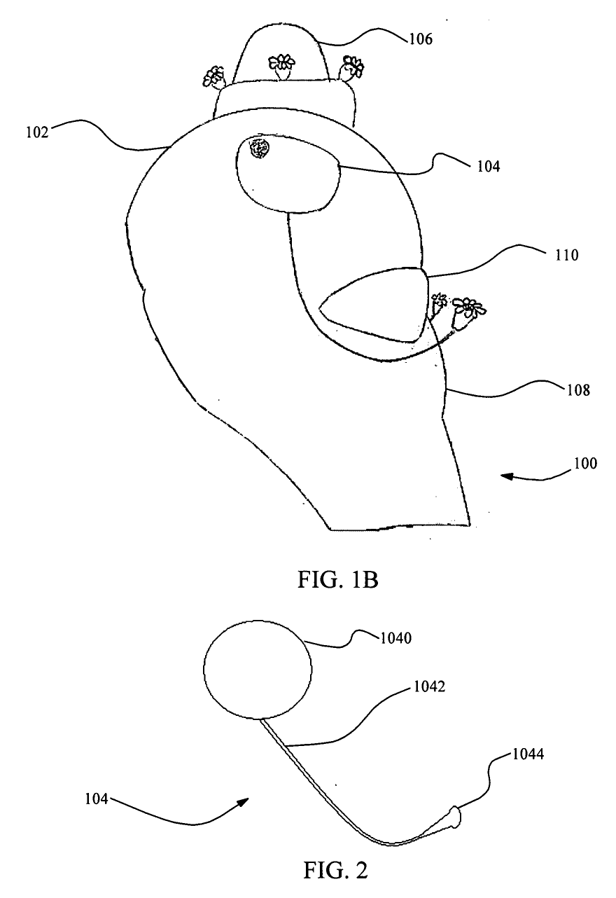

FIG. 2 shows an example of a side feeder 104 for either side of the mask 102. The side feeders 104 may be, for example, platform, hopper, suet, tube, and nectar birdfeeders. In this example, the side feeder 104 is a bulb feeder. Each bulb feeder 104 includes a bulb shaped reservoir 1040. The reservoir 1040 is a thin walled container with an aperture (not shown) through the exterior surface. The aperture allows for the reservoir to be filled with fluid or to have fluid extracted from the reservoir. One end of a tube 1042 is inserted into the aperture. A fluid tight seal adheres the tube 1042 to the reservoir 1040. Preferably, the tube 1042 is hooked shape. The food dispenser 1044 is connected to the other end of the tube 1042.

Initially the reservoir 1040 is filled with hummingbird food, e.g. sugar water or nectar. The hummingbird food, in the reservoir, then drains into the tube 1042. The hummingbird food then pours into the food dispenser 1044 from the tube 1042, where the food is accessible to hummingbirds. Optionally, the side feeders 104 may include bleeder valves (not shown) for controlling fluid flow. The optionally bleeder valves may be slightly cracked open to allow fluid to flow freely down the thin tube 1042 and into the food dispenser (e.g., a flower). Also, a side feeder fitted with such bleeder valves may be adapted for the front with a flower dispenser at the tip of wearer's nose. Further, for additional flow control, a hose (not shown) may be attached at one end to an air intake (not shown) at the top or side of the reservoir 1040 for remotely controlling fluid flow, e.g., manually plugging/unplugging the hose or, with the other end attached to the bleeder valve and manually switching the bleeder valve or holding the bleeder valve open.

Preferably, the food dispenser 1044 is located for optimal visibility of the feeding hummingbirds. So, when the side feeder 104 is attached to one side of the mask 102, the tube 1042 and dispenser 1044 hang below the reservoir 1040. Thus, the tube 1042 is bent towards the front of the mask 102, such that the dispenser 1044 is in the line of sight of the user.

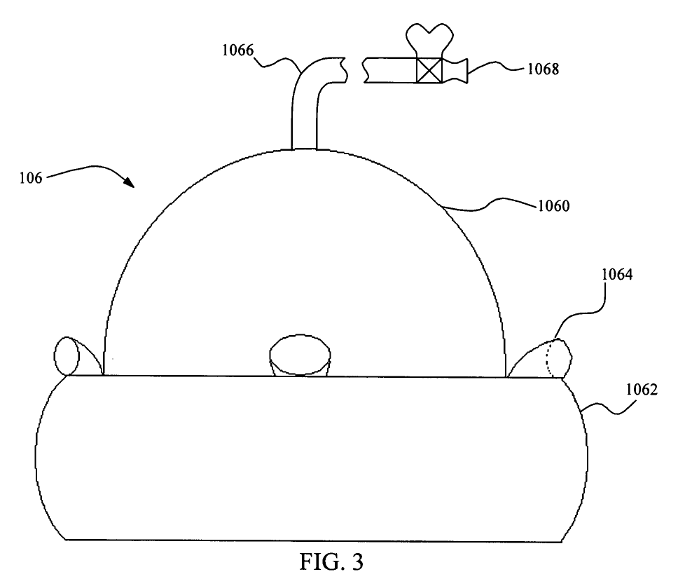

FIG. 3 shows an example of a top feeder 106, which sits on top of the mask 102 in this example. The top feeders 106 may be, for example, platform, hopper, suet, tube, and nectar birdfeeders. In this example the top feeder 106 is a nectar birdfeeder with a reservoir 1060 sits on a base 1062. The base 1062 sits flush on the top of the mask 102. There are four food dispensers 1064 in this example attached to the base 1062 of the top feeder 106. The food dispensers 1064 are arranged in a square pattern around the reservoir 1060. Ducts (not shown) allow food to flow from each reservoir 1060 to the food dispenser 1064. This example also shows, an optional hose 1066 attached at one end to an air intake at the top or side of the reservoir 1066 for additional flow control. A bleeder valve 1068 at the other end of the hose 1066 provides for remotely controlling fluid flow, manually switching the bleeder valve or holding the bleeder valve open or closed. Alternately, instead of the bleeder valve 1068, a plug (not shown) may be used to manually plug/unplug the hose

The reservoir 1060 may be filled with hummingbird food. The ducts drain the food into the food dispenser 1064 again making the food readily available to hummingbirds.

Advantageously, when the personal hummingbird blind 100 is worn correctly, hummingbirds come within inches of the mask 102. The user is able to view hummingbirds right up in his/her face, without scaring the hummingbirds. Since the feeders in the preferred embodiment blind are tightly located around the user's head, the feeders are less sensitive to head movement. Thus, the open fluid containers tend to splash less fluid with any amount of movement; wasted bird food is dramatically reduced.

While the invention has been described in terms of preferred embodiments, those skilled in the art will recognize that the invention can be practiced with modification within the spirit and scope of the appended claims. It is intended that all such variations and modifications fall within the scope of the appended claims. Examples and drawings are, accordingly, to be regarded as illustrative rather than restrictive.

I claim:

1. A blind for attracting and observing animals comprising:
a head covering; and
one or more animal feeders directly attached to said head covering.

2. A blind as in claim 1, wherein said head covering is selected from the group comprising:
a welding helmet;
a beekeeper's mask;
a construction helmet;
a bandana;
a hood;
a cloak; and
a Halloween mask.

3. A blind as in claim 1, further comprising a breath diverter at a front side of the head covering.

4. A blind as in claim 3, wherein said breath diverter is selected from the group comprising:
a surgeon's mask;
a welding mask; and
a bandanna.

5. A blind as in claim 3 further comprising an eye guard is disposed on the head covering above the breath diverter such that when said head covering is worn, the eye guard is disposed over the wearer's eyes.

6. A blind as in claim 5, wherein said eye guard is selected from the group comprising:
safety glasses;
sunglasses;
a welding mask;
a beekeeper mask; and
goggles.

7. A blind as in claim 3, further comprising a bird perch attached to said breath diverter such that when said head covering is worn, said bird perch is disposed in the line of sight of the wearer.

8. A blind as in claim 3, wherein said animal feeders are hummingbird feeders.

9. A blind as in claim 8, wherein said hummingbird feeders comprise side feeders and a top feeder and one or more of said hummingbird feeders including flow control.

10. A blind as in claim 1, wherein said head covering includes a breath diverter at a front side.

11. A blind as in claim 10, wherein said head covering is a mask and further comprises a pair of lenses at eyeholes in said mask.

12. A blind as in claim 11, further comprising a bird perch at said breath diverter and disposed in front of said eyeholes.

13. A blind as in claim 12, wherein said animal feeders comprise side hummingbird feeders and a top hummingbird feeder attached to said mask.

14. A wearable hummingbird blind for observing feeding hummingbirds in close proximity, said hummingbird blind comprising:
head covering colored to draw hummingbirds and suitable for hiding from view at least a human forehead;
a breath diverter disposable at the front of said head covering at the nose of a wearer wearing said head covering; and
one or more wearable birdfeeders adapted to be worn on the human head, whereby said breath diverter prevents birds drawn to said one or more wearable birdfeeders from being disturbed by the breath of said wearer wearing said wearable hummingbird blind.

15. A wearable hummingbird blind as in claim 14, wherein said head covering has a floral coloring and camouflages a human head, said head covering being selected from the group comprising:
a welding helmet;
a beekeeper's mask;
a construction helmet;
a bandana;
a hood;
a cloak; and
a Halloween mask.

16. A wearable hummingbird blind as in claim 14, wherein said breath diverter is selected from the group comprising:
a surgeon's mask;
a welding mask; and
a bandanna.

17. A wearable hummingbird blind as in claim 14, further comprising an eye guard is disposed on the head covering above the breath diverter such that when said head covering is worn, the eye guard is disposed over the wearer's eyes, said eye guard being selected from the group comprising:
safety glasses;
sunglasses;
a welding mask;
a beekeeper mask; and
goggles.

18. A hummingbird feeder comprising:
floral colored headwear, colored to draw hummingbirds and suitable for hiding from view at least a human forehead;
a breath diverter at the front of said headwear and capable of covering the nose of a wearer wearing said head covering; and
one or more hummingbird feeders attached to the headwear.

19. A hummingbird feeder as in claim 18, said head wear being selected from the group comprising:
a welding helmet;
a beekeeper's mask;
a construction helmet;
a bandana;
a hood;
a cloak; and
a Halloween mask.

20. A hummingbird blind as in claim 19, wherein said headwear is an upper portion of a floral colored mask and said breath diverter is a lower portion.
